(19) United States
(12) Patent Application Publication
(10) Pub. No.: US 2025/0379758 A1
(43) Pub. Date: Dec. 11, 2025

(54) METHODS FOR GROUPING TRANSACTIONS IN BLOCKCHAIN, AND BLOCKCHAIN NODES

(71) Applicant: Ant Blockchain Technology (Shanghai) Co., Ltd., Shanghai (CN)

(72) Inventor: Dayi Yang, Hangzhou (CN)

(73) Assignee: Ant Blockchain Technology (Shanghai) Co., Ltd., Shanghai (CN)

(21) Appl. No.: 19/312,877

(22) Filed: Aug. 28, 2025

Related U.S. Application Data
(63) Continuation of application No. PCT/CN2023/135005, filed on Nov. 29, 2023.

(30) Foreign Application Priority Data
Feb. 28, 2023 (CN) 202310183750.6

(51) Int. Cl. H04L 9/00

(52) U.S. Cl. CPC H04L 9/50

(57) ABSTRACT

Disclosed are methods, apparatuses, and systems for grouping transactions in a blockchain. In an example method, a plurality of first transactions are obtained from a plurality of transactions that are to be grouped, where the plurality of first transactions invoke the same contract; a set of identifiers corresponding to one or more state variables of the contract that is to be accessed by each of the first transactions is determined, where the set of identifiers includes variable identifiers of the state variables during contract execution, and the variable identifiers are used to determine keys of the state variables in a state database; and the plurality of first transactions are grouped according to the set of identifiers of each of the first transactions.

### CROSS-REFERENCE TO RELATED APPLICATIONS

This application is a continuation of PCT Application No. PCT/CN2023/135005, filed on Nov. 29, 2023, which claims priority to Chinese Patent Application No. 202310183750.6, filed on Feb. 28, 2023, and each application is hereby incorporated by reference in its entirety.

### TECHNICAL FIELD

Embodiments of this specification belong to the field of blockchain technologies, and particularly relate to methods for grouping transactions in a blockchain, and blockchain nodes.

### BACKGROUND ART

Blockchains are a novel application model of computer technologies such as distributed data storage, peer-to-peer transmission, consensus mechanisms, and encryption algorithms. In blockchain systems, data blocks are organized into a chain data structure in chronological order, and distributed ledgers that cannot be tampered with or forged are cryptographically ensured. The blockchains have characteristics such as decentralization, tamper-resistance of information, and autonomy, and therefore the blockchains have received increasing attention and applications.

### SUMMARY

An objective of this application is to provide solutions for grouping transactions in a blockchain, so as to improve performance of transaction grouping in the blockchain.

A first aspect of this specification provides methods for grouping transactions in a blockchain. The method is executed by a blockchain node, and includes the following steps: a plurality of first transactions are obtained from a plurality of transactions that are to be grouped, where the plurality of first transactions invoke the same contract; a set of identifiers corresponding to one or more state variables of the contract that is to be accessed by each of the first transactions is determined, where the set of identifiers includes variable identifiers of the state variables during contract execution, and the variable identifiers are used to determine keys of the state variables in a state database; and the plurality of first transactions are grouped according to the set of identifiers of each of the first transactions.

A second aspect of this specification provides blockchain nodes. The blockchain node includes: an obtaining unit configured to obtain a plurality of first transactions from a plurality of transactions that are to be grouped, where the plurality of first transactions invoke the same contract; a determination unit configured to determine a set of identifiers corresponding to one or more state variables of the contract that is to be accessed by each of the first transactions, where the set of identifiers includes variable identifiers of the state variables during contract execution, and the variable identifiers are used to determine keys of the state variables in a state database; and a grouping unit configured to group the plurality of first transactions according to the set of identifiers of each of the first transactions.

A third aspect of this specification provides a computer-readable storage medium. The computer-readable storage medium stores a computer program. When the computer program is executed in a computer, the computer is caused to execute the method according to the first aspect.

A fourth aspect of this specification provides blockchain nodes. The blockchain node includes a memory and a processor. The memory stores executable codes. The processor executes the executable codes to implement the method according to the first aspect.

In the solutions provided by the embodiments of this specification, for the plurality of transactions invoking the same contract, the identifiers of the state variables that are to be accessed by each of the transactions in contract execution are determined, such that the plurality of transactions are grouped according to the identifiers of the state variables requested to be accessed by each of the transactions. Thus, computational load and storage resource usage of transaction grouping are reduced, granularity of transaction grouping is improved, and parallelism of transaction execution is further enhanced.

### BRIEF DESCRIPTION OF THE DRAWINGS

To describe technical solutions in embodiments of this specification more clearly, the accompanying drawings for description of the embodiments will be briefly introduced below. Clearly, the accompanying drawings in the following description are merely some embodiments of this specification, and a person of ordinary skill in the art can still derive other drawings from these accompanying drawings without creative efforts.

FIG. 1 is a schematic diagram illustrating deployment of a smart contract in some embodiments;

FIG. 2 is a schematic diagram illustrating invoking of a smart contract in some embodiments;

FIG. 3 is a schematic diagram illustrating a block storage structure in some embodiments;

FIG. 4 is a schematic diagram illustrating a block storage structure in some embodiments;

FIG. 5 is a schematic diagram illustrating an Ethereum virtual machine (EVM) module involved in transaction processing in some embodiments;

FIG. 6 is a schematic diagram illustrating a slot structure in some embodiments;

FIG. 7 is a schematic diagram illustrating a slot structure in some embodiments;

FIG. 8 is a flowchart illustrating a method for grouping transactions in a blockchain in embodiments of this specification;

FIG. 9 is a flowchart illustrating a method for grouping transactions in embodiments of this specification; and

FIG. 10 is a structural diagram illustrating a blockchain node in embodiments of this specification.

### DETAILED DESCRIPTION OF THE EMBODIMENTS

In order to enable a person skilled in the art to better understand technical solutions in this specification, the technical solutions in embodiments of this specification will be clearly and completely described in combination with the accompanying drawings in the embodiments of this specification. Clearly, the described embodiments are merely some embodiments rather than all embodiments of this specification. All other embodiments obtained by a person of ordinary skill in the art based on the embodiments of this specification without creative efforts should fall within the protection scope of this specification.

In order to enable a person skilled in the art to better understand technical solutions in this specification, the technical solutions in embodiments of this specification will be clearly and completely described in combination with the accompanying drawings in the embodiments of this specification. Clearly, the described embodiments are merely some embodiments rather than all embodiments of this specification. All other embodiments obtained by a person of ordinary skill in the art based on the embodiments of this specification without creative efforts should fall within the protection scope of this specification.

Blockchains are generally classified into three types: public blockchains, private blockchains, and consortium blockchains. In addition, there are combinations of a plurality of types, such as combinations of private blockchains and consortium blockchains, and combinations of consortium blockchains and public blockchains. The public blockchains have the highest degree of decentralization. Bitcoin and Ethereum are examples of public blockchains. Participants that join the public blockchains can read data records in the blockchains, participate in transactions, contend for ledger permission of new blocks, etc. In addition, each of the participants (embodied as nodes of the participants in the blockchains) can freely join and exit networks and perform related operations. The private blockchains are opposites of the public blockchains. Writing permission of the networks is controlled by an organization or an institution, and data reading permission is specified by the organization. In short, the private blockchain can be a weakly centralized system, and has less participating nodes with strict restrictions. This type of blockchains are more suitable for internal use of specific institutions. The consortium blockchains lic between the public blockchains and the private blockchains, achieving “partial decentralization”. Each of the nodes in the consortium blockchains generally has a corresponding entity institution or organization. Participants are authorized to join the networks and constitute a stakeholder alliance, and jointly maintain running of the blockchains.

Most of the public blockchains, the private blockchains and the consortium blockchains can provide a function of smart contracts. The smart contracts in the blockchains are contracts whose execution can be triggered by transactions in a blockchain system. The smart contracts can be defined in a form of codes.

With the Ethereum as an example, supporting users in creating and invoking some complex logics in an Ethereum network is the biggest challenge of the Ethereum to be different from the Bitcoin blockchain technology. The Ethereum is a programmable blockchain, and a core of Ethereum is an Ethereum virtual machine (EVM). Each Ethereum node can run the EVM. The EVM is a Turing-complete virtual machine, which means that various complex logics can be implemented through the EVM. Deploying and invoking smart contracts in the Ethereum by the users are implemented by the EVM. In fact, the virtual machine directly runs virtual machine codes (virtual machine bytecodes, referred to as “bytecodes” below). The smart contracts deployed on the blockchains can be in a form of bytecodes.

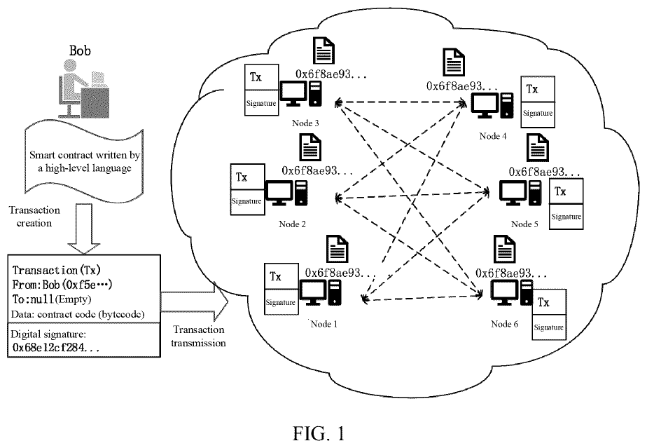

For example, as shown in FIG. 1, after Bob transmits a transaction that includes information for creating smart contracts to the Ethereum network, an EVM of node 1 can execute the transaction and generate a corresponding contract example. “0x6f8ae93 . . . ” in FIG. 1 represents an address of the contract, a data field of the transaction can store bytecodes, and a to field of the transaction is an empty account. After nodes reach an agreement through consensus mechanisms, the contract is successfully created, and then the users can invoke the contract.

After the contract is created, a contract account corresponding to the smart contract appears in the blockchains and has a specific address. Contract codes and account storage are stored in the contract account. Behaviors of the smart contracts are controlled by the contract codes, and the account storage of the smart contracts stores the states of the contract. In other words, the smart contracts enable a virtual account including the contract codes and the account storage to be generated on the blockchain.

As mentioned above, the data field of the transaction including creation of the smart contract can store bytecodes of the smart contract. The bytecodes include a series of bytes, and each of the bytes can identify an operation. Considering development efficiency, readability, etc., developers can choose a high-level language to write smart contract codes instead of writing bytecodes directly. The smart contract codes written in the high-level language are compiled by compilers, bytecodes are generated, and then the bytecodes can be deployed in the blockchains. The Ethereum supports many high-level languages, such as Solidity, Serpent, and Low-Level Lisp-like (LLL) Language.

With Solidity as an example, contracts written in Solidity are similar to classes in object-oriented programming languages. A plurality of members can be stated in a contract, and include state variables, functions, function modifiers, events, etc. The state variables are values permanently stored in the account storage of the smart contracts, and are used to keep the states of the contracts.

Code example 1 of a simple smart contract written in Solidity is as follows:

| | |
|---|---|
| 1 | Contract SimpleStorage { |
| 2 | string storedData; |
| 3 | event stored(address from, string s) |
| 4 | function set(string s) { |
| 5 | storedData = s; |
| 6 | stored(msg.sender, s); |
| 7 | } |
| 8 | function get( ) constant returns (string) { |
| 9 | return storedData; |
| 10 | } |
| 11 | } |

### Code Example 1, SimpleStorage Codes

In the above-mentioned code example 1, a state variable storedData of a character type of a string is stated in line 2, and an event is stated in line 3. The event stores an address of an initiator invoking the contract and the string s. Lines 4-7 define a set function, and input parameters are strings s. Operations executed by the set function include setting the input parameters to the state variable storedData, and generating an event. Contents of the event include the address of the initiator invoking the contract and the string s.

As mentioned above, the state variables are eventually stored in a database. The generated events are generally in the following form:
[topic1] [topic2] . . . [topicn] [data]

Herein, a first topic, that is, topic 1, is generally a default value, such as an identifier of a receipt, which can be a hash value obtained by sequentially splicing an event name and an event parameter type. In topic2 to topicn, whether each topic exists depends on whether an indexed modification is added during parameter definition. If yes, a value of the parameter is a topic in a receipt, and parameters without indexed modifications are generally put into data. In an example in the code example 1, when an event is stated in line 3, two parameters of address from and s without indexed modifications are generally put into data. Codes in line 6 set data contents [msg.sender,s] in an event through a stored ( ) event. Thus, for events operated in the line 6, an overall form is as follows:
[topic1: event identifier] [data: msg.sender,s]

Lines 8-10 define a get function. Operations of the function include returning an inquired value of storedData, returns (string) indicate types of return values, and constant modifiers indicate that the function cannot modify values of the state variables in the contract.

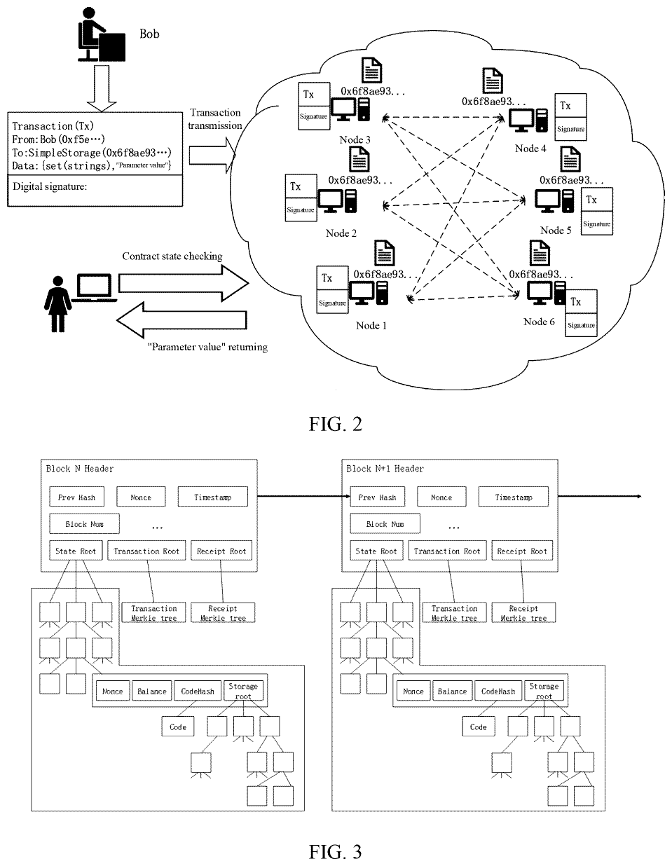

In addition, as shown in FIG. 2, still with the Ethereum as an example, after Bob transmits a transaction that includes information for invoking smart contracts to the Ethereum network, an EVM of node 1 can execute the transaction and generate a corresponding contract example. From fields of transactions in FIG. 2 are addresses of accounts that initiate invoking of the smart contracts, “0x6f8ae93 . . . ” in to fields represents an address of the invoked smart contract, and data fields of transactions store methods and parameters for invoking the smart contracts. In addition, value fields can be further included to indicate values of Ethers in the transaction. After the smart contracts are invoked, the value of storedData may be changed. Then, a certain client device can check a current value of storedData through a certain blockchain node (for example, node 6 in FIG. 2).

The smart contract can be executed independently by each node in a blockchain network in a specified way, and all execution records and data are stored on the blockchain. Thus, when such transactions are completed, transaction vouchers that cannot be tampered with and cannot be lost are stored on the blockchain.

As mentioned above, storedData in the above-mentioned examples is the state variable, and is stored in the account storage of the smart contracts. In various blockchain networks that introduce the smart contracts, with the Ethereum as an example, accounts can generally include two types: contract accounts that store executed smart contract codes and values of states in the smart contract codes, which can merely be invoked and activated through externally owned accounts; and externally owned accounts that are accounts of users, such as accounts of Ether owners.

Designs of the externally owned accounts and the contract accounts are actually mapping of account addresses to account states. The account states generally include fields such as Nonce, Balance, Storage root, and CodeHash. The Nonce and the Balance exist in both the externally owned accounts and the contract accounts. The CodeHash and Storage root attributes are generally merely valid on the contract accounts.

The Nonce indicates a counter. For the externally owned accounts, the number can represent the number of transactions transmitted from the account addresses. For the contract accounts, the number can be the number of contracts created by accounts.

The Balance indicates the number of Ethers owned by the address.

The Storage root is a hash of a root node of a Merkle Patricia tree (MPT). The MPT organizes storage of state variables of the contract accounts.

The CodeHash is a hash value of the smart contract codes. For the contract accounts, the CodeHash is a hash value of the smart contracts. For the externally owned accounts, the smart contracts are not included, so CodeHash fields can generally be empty strings/all-0 strings.

A full name of the MPT is the Merkle Patricia Tree, which is a tree structure that combines the Merkle Tree and the Patricia Tree (a compressed prefix tree that is a more space-saving trie). A Merkle Tree algorithm computes a hash value for each transaction, and then computes Hash by connecting every two hash values, until a top Merkle root is reached. An improved MPT, for example, a structure of a 16-branch tree, is used in the Ethereum, which is generally referred to as the MPT for short.

A data structure of an Ethereum MPT includes a state trie. The state trie includes a key and value pair (also referred to as a key-value, or k-v or kv for short) of a storage content corresponding to each account in the Ethereum network. The “key” in the state trie can be a 160-bits identifier (for example, an address of an Ethereum account or part of a hash value of an address, hereinafter collectively referred to as the account address), and the account address is distributed in storage from a root node to a leaf node of the state trie. The “value” in the state trie is generated by encoding information of the Ethereum account (through a recursive-length prefix encoding (RLP) method). As mentioned above, for the externally owned accounts, values include nonce and balance. For the contract accounts, values include nonce, balance, codchash, and storageroot.

The contract accounts are used to store states related to the smart contracts. After the smart contract is deployed on the blockchain, a corresponding contract account can be generated. This contract account can generally have some states. The states are defined by the state variables in the smart contracts and generate new values when the smart contracts are executed. The smart contracts generally refer to contracts defined in a code form in a blockchain environment and capable of automatically executing terms. Once an event triggers terms in the contract (satisfies execution conditions), codes can be automatically executed. In the blockchain, relevant states of the contract are stored in a storage tric, and a hash value of a root node of the storage tric is stored in above-mentioned storageroot, such that all the states of the contract are locked to the contract account through hash. The storage trie is also a MPT tree structure, and stores key-value mapping from state addresses to state values. Part of information from the root node to a leaf node of the storage trie is sequentially arranged to store an address of a state. The leaf node stores a value of the state.

In some blockchain data storage shown in FIG. 3, a block header of each block includes several fields, and for example, a previous block hash previous_Hash (Prev Hash in the figure), a random number Nonce (the Nonce is not a random number in some blockchain systems, or the nonce in the block header is not enabled in some blockchain systems), a time stamp Timestamp, a block number Block Num, a state root hash State_Root, a transaction root hash Transaction_Root, and a receipt root hash Receipt_Root. Prev Hash in a block header of a next block (for example, a block N+1) points to a previous block (for example, a block N), that is, a hash value of the previous block. In this way, locking of the next block to the current block is implemented in the blockchain through the block header. The State_Root, the Transaction_Root and the Receipt_Root lock a state set, a transaction set and a receipt set, respectively. The state set, the transaction set and the receipt set organize states, transactions and receipts in a form of trees, respectively. Generally, they can be of the same tree structure, or different tree structures. For example, in the Ethereum, the same MPT structure is used. Some tree structures, such as the Ethereum, including state sets of the smart contracts, include MPT structures of two levels: leaf nodes of a previous-level MPT structure have two types of externally owned accounts and contract accounts; each of the contract accounts includes a next-level MPT structure, and leaf nodes of a next level include values of states in the contract accounts.

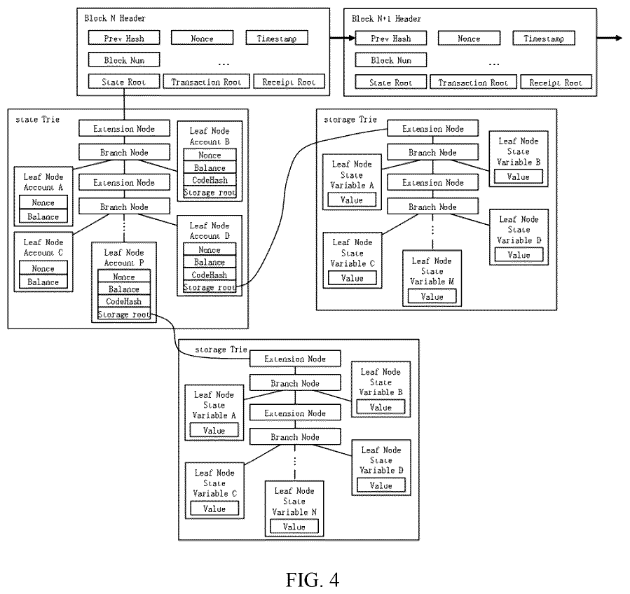

FIG. 4 is a schematic structural diagram illustrating data storage of a blockchain. Still with the Ethereum as an example, it can be seen in FIG. 3 that state_root is a hash value of a root of an MPT including states of all accounts in a current block, that is, a state trie in a form of an MPT points to the state_root. A root node of the MPT is generally an extension node or a branch node, and a hash value of the root node is generally stored in the state_root. The root node can be connected to one or more layers of extension nodes/branch nodes below, and the layers of tree nodes can be collectively referred to as internal nodes. Some values from the root node to each node in leaf nodes of the MPT can be connected in series sequentially so as to constitute an account address and serve as a key, and account information stored in the leaf nodes is a value corresponding to the account address. Thus, a key-value pair is formed. The key can also be a part taken after sha3 (Address), that is, part of a hash value of the account address (for example, a sha3 algorithm is used as a hash algorithm), and a stored value can be rlp (Account), that is, an rlp code of the account information. The account information is a quaternion of [nonce, balance, storageRoot, codeHash]. As mentioned above, for an externally owned account, there are generally only two items: nonce and balance, and storageRoot and codeHash fields store empty strings/all-0 strings by default. That is, the externally owned accounts store no contracts, and store no state variables generated after contracts are executed. Contract accounts generally include Nonce, Balance, Storage root, and CodeHash. The Nonce is a transaction counter of the contract account. The Balance is the account balance. The Storage root corresponds to another MPT, and can be linked to contract-related state information through the Storage root. The CodeHash is a hash value of a contract code. Account information of an externally owned account or a contract account is generally located in a separate leaf node. From an extension node/branch node of the root node to a leaf node of each account, several branch nodes and extension nodes may be passed.

The state trie can be a tree in a form of MPT, and generally a 16-branch trec. That is, each layer can have up to 16 child nodes. The extension node is used to store common prefixes, and generally has 1 child node. The child node can be a branch node. The branch node can have up to 16 child nodes, which may include an extension node and/or a leaf node.

For a contract account in the state trie, its storage_Root points to another tree in a form of MPT, and stores data of state variables involved in contract execution. The tree, pointed by the storage_Root, in a form of MPT is a storage trie, which is a hash value of a root node of the storage trie. Generally, the storage trie also stores key-value pairs. The key indicates an address of the state variable, and a value of the key can be a result obtained by processing a stated position of the state variable (a value counted from 0) in the contract according to certain rules, such as sha3 (a stated position of the state variable), or sha3 (a contract name+a stated position of the state variable). The value is used to store a value of the state variable (such as an RLP-encoded value). Some data stored on a path from the root node to the leaf nodes through an internal node are connected to constitute the key, and the leaf nodes store the value. As mentioned above, the storage trie can be a tree in a form of MPT, and generally a 16-branch tree. That is, the branch node may have up to 16 child nodes. The child nodes may include an extension node and/or a leaf node. The extension node can generally have 1 child node. The child node can be a branch node or a leaf node.

For example, Leaf Node Account P of the state tric in FIG. 4 is a contract account, and its storage root locks all states in the contract storage. The states are organized to form a MPT, and a tree structure is like a storage trie linked by the storage root. In the linked storage tric, for example, if Leaf Node State Variable N is a value of the storedData in the example of the contract code, its key can be, but is not limited to, sha 3 (the stated position of the storedData), and its value is s (for brevity, an encoding format of the value is omitted herein, such as RLP, and the following contents are shown in a similar way and will not be repeated herein). Values of the key are sequentially distributed from the root node to the leaf nodes (that is, Leaf Node Variable N) of the storage trie.

For another example, Leaf Node Account C in the state trie in FIG. 4 is an externally owned account, its key is sha3 (Address C), that is, a hash value of an address of the account C (for example, a sha3 algorithm is used as a hash algorithm), and its stored value can be (Account). Account information Account is a binary group of [nonce, balance]. As mentioned above, Account C is an externally owned account, so its account information includes nonce and balance (codehash and storage root are not included herein, and the following contents are shown in a similar way). For example, if an externally owned account has nonce of 20 and Balance of 4550, a leaf node of Leaf Node State Variable C stores nonce=20 and balance=4550. An address of Account C is a key, and values of the key are sequentially distributed from the root node to the leaf node (that is, Leaf Node Variable C) of the state trie.

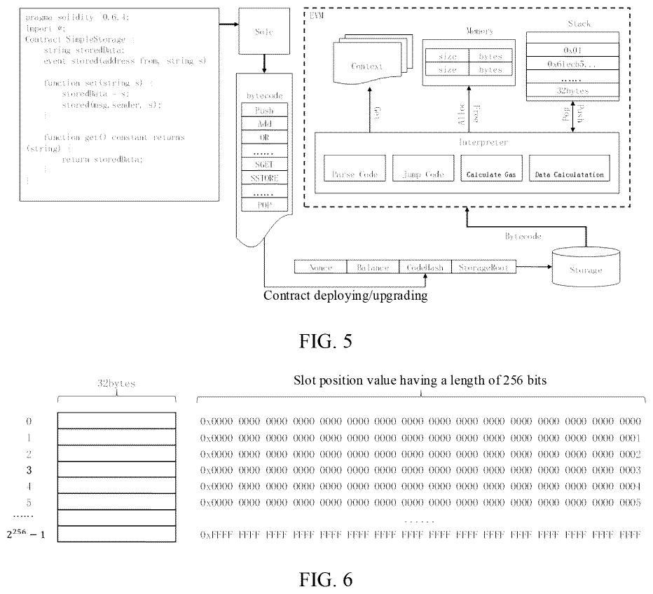

As mentioned above, after the transaction for creating a smart contract is transmitted to the blockchain and a consensus about the transaction is reached in the blockchain, each node of the blockchain can execute the transaction. In this case, a contract account corresponding to the smart contract appears on the blockchain (which includes an identity of the account, a hash value Codehash of the contract, and a root StorageRoot of contract storage for example), and has a specific address. The contract code and the account storage can be stored in storage of the contract account, as shown in FIG. 5. Behaviors of the smart contracts are controlled by the contract codes, and the account storage of the smart contracts stores the states of the contract. In other words, the smart contracts enable a virtual account including the contract codes and the account storage to be generated on the blockchain. For a contract deployment transaction or a contract update transaction, a value of Codehash can be generated or changed. Subsequently, the blockchain node can receive a transaction request invoking the deployed smart contract. The transaction request can include an address of the invoked contract, a function in the invoked contract, and input parameters. Generally, after the transaction request reaches a consensus, each node of the blockchain can independently execute the specially invoked smart contract.

A left side of FIG. 5 shows an example of a smart contract written in solidity and its compilation and execution process. The smart contract is compiled by a compiler to generate bytecodes, and solc in the figure is a command-line compiler of solidity. An Ethereum smart contract compiled in solidity can be compiled by a command-line tool sole with parameters, so as to generate bytecodes that can be run on the EVM. After the contract deployment process the in FIG. 1, the smart contract can be successfully created on the blockchain. After the contract is deployed, a contract account corresponding to the smart contract is generated on the blockchain. The contract account includes, for example, a contract counter Nonce, the balance of the account, a hash value Codehash of contract bytecodes, a root StorageRoot of contract storage, etc. The contract can have a specific address in the chain, which is a contract address.

The contract address is, for example, obtained through hash computation in the Ethereum according to an address of an externally owned account that deploys the contract and its counter nonce. Specifically, for example, for sha3 (rlp.encode ([address_sender, nonce])) (rlp is an encoding format as mentioned above, and can be replaced by other encoding formats in different blockchains, even without re-encoding, so the rlp is omitted later). Sha3 is a hash algorithm, such as an algorithm of keccak256 often used. The rlp represents an encoding format as mentioned above, and rlp.encode ([address_sender, nonce]) indicates rlp encoding of contents in parentheses. [address_sender, nonce] in parentheses indicates that an address address_sender of the externally owned account that deploys the contract and its counter nonce are sequentially spliced. For example, through a keccak256 algorithm, a hash value having a length of 256 bits can be obtained, and according to the hash value, an address of the deployed contract on the blockchain can be obtained (for example, first 20 bytes are taken). 256 bits are equal to 32 bytes. The balance of the account can be set to a default value 0 when deployment is completed. The hash value Codchash of the contract bytecodes can be obtained by a blockchain platform through hash computation of the contract bytecodes. The root StorageRoot of the contract storage can be a default value or a hash value computed according to a root node of a lower storage trie, which generally depends on whether an initialization operation, such as execution of a constructor in the contract, is performed in the deployed contract. If the deployed contract includes a constructor, the deployed contract can generally include initialization of some state variables that are to be eventually stored in an underlying database. The initialization can be executed in a virtual machine. Initialized state variables, as mentioned above, can cracte an MPT, such that a root node of the MPT can be obtained, and further a hash value of the root node can be obtained. If the deployed contract includes no constructor, a specific function cannot be executed, and a blockchain platform can give a default value to StorageRoot, such as a hash value of an empty content.

After the contract is deployed, as mentioned above, the contract can be invoked later. As shown in FIG. 2, after Bob initiates a transaction for invoking a smart contract to the Ethereum network, the contract is executed, such that a state variable is set as a string “hello”.

Execution of the contract can be specifically as shown in FIG. 5. For example, a transaction for invoking a contract in FIG. 2 is transmitted to the blockchain network, and after consensus, each node can execute the transaction. A to field of the transaction indicates an address of the invoked contract. Any node can identify storage of a contract account according to the address of the contract, and then can read Codehash from the storage of the contract account, so as to identify corresponding contract bytecodes according to the Codehash. The node can load the contract bytecodes from storage to a virtual machine. Further, execution is interpreted by an interpreter, and for example, include the following steps: the bytecodes of the invoked contract (such as Push, Add, SGET, SSTORE, and Pop) are parsed, OPcodes and functions are obtained, and the OPcodes are stored to a memory opened by the virtual machine (alloc in the figure; and for example, Free in the figure, which corresponds to a memory release operation after program execution). Meanwhile, a jump position JumpCode of an invoked function in the memory is obtained. Generally, after Gas to be consumed for contract execution is computed and Gas is sufficient, a corresponding address of the memory is jumped to, an OPcode of the invoked function is obtained and starts to be executed. Data computation, an operation of pushing into/out of stacks and other operations are performed on data operated by the OPcode of the invoked function, such that data computation is completed. In the process, some contract context information may be needed, such as block numbers, and information of an initiator for invoking the contract. The information can be obtained from context (Get operation). Finally, a generated state is stored in database storage by invoking a storage interface. It should be noted that during contract creation, execution of some functions, such as a function of an initialization operation, in the contract may be produced. In this case, codes can be parsed, jump instructions can be generated, storage to the memory can be performed, and operations to the stacks can be performed.

Through the above-mentioned process, the virtual machine loads and executes the contract bytecodes, and states may be generated and/or read, such that the underlying database needs to be accessed. The virtual machine needs to conveniently access an underlying key value (KV) database. Generally, an ability of accessing data similar to a pointer can be used to access the KV database. For example, in the Ethereum, if a value corresponding to a key needs to be read from the KV database, a key of the data needs to be known before access.

Each contract generally has its own virtual storage space. Capacity of the virtual storage space can be a very large array, such as an array with 2256 elements numbered from 0 to 2256-1. Each element can occupy a certain length, and for example, 32 bytes. Each element is referred to as a slot herein. It should be noted that a total storage space of 2256 slots is total capacity of a virtual space. That is, unused slots do not occupy an actual storage space of the underlying database.

When the virtual machine executes the contract bytecodes, a slot position of the same state variable in the virtual storage space needs to be fixed, such that the key generated by contract execution can be fixed generally after contract codes are determined. Thus, fixation of the position of the state variable is generally decided during compilation of the compiler, which is not directly related to the virtual machine.

A compiling process of the compiler can roughly include the following steps: an abstract syntax tree is generated, lexical/grammatical analysis is performed according to the abstract syntax tree, symbols are applied according to a symbol table, and semantic analysis and code generation are performed. The abstract syntax tree includes a plurality of nodes arranged sequentially. The plurality of nodes correspond to a plurality of objects stated in the contract. An arrangement order of the plurality of nodes corresponds to stated positions of the plurality of objects in the contract. The plurality of objects include first state variables. In the process of lexical/grammatical analysis according to the abstract syntax tree, slot position information of the state variables of the contract can be generated. Assuming that codes of contract C1 are as follows:

```
contract C1 {
unit256 A;
bool B;
//mapping from token ID to owner
mappping(uint256 => address) tokenOwner
//mapping from owner to number of owned token
mappping(uint256 => Counter) ownedTokensCount
  function setA(uint256 x) public {
    A = x;
  }
  function getA( ) public view returns(unit256) {
    return A;
  }
  function setB(bool t) public {
    B= t;
  }
  function getB( ) public view returns(bool) {
    return B;
  }
  function mint(address to,uint256 tokenid) public {
    tokenOwner[tokenid]=to;
    ownedTokensCount[to],increment( )
  }
}
```

### Code Example 2. Solidity Codes of Contract C1

According to the contract codes. for example, an abstract syntax tree is generated as follows:

| | | |
|---|---|---|
| 1 | “name”: “C1”, | //Contract name |
| 2 | “nodeType”: “ContractDefinition”, | //Node type: contract definition |
| 3 | “nodes”: | //Included node |
| 4 | [ | |
| 5 | { | |
| 6 | “constant”: false, | //Is it a constant? |
| 7 | “name”: “A”, | //Variable name |
| 8 | “nodeType”: “VariableDeclaration”, | //Node type: variable statement |
| 9 | “overrides”: null, | //Whether to overwrite a variable in an inherited |
| | | contract |
| 10 | “stateVariable”: true, | //Is it a state variable? |
| 11 | “storageLocation”: “default”, | //Storage position (computed according to a default |
| | | computation rule) |
| 12 | “typeDescriptions”: | //Type description |
| 13 | { | |
| 14 | “typeIdentifier”: “t_uint256”, | //Type description |
| 15 | “typeString”: “uint256” | //String representation of type description |
| 16 | }, | |
| 17 | “value”: null, | //Whether to assign an initial value |
| 18 | “visibility”: “internal” | //Visibility: internal |

| | |
|---|---|
| 19 | }, |
| 20 | { |
| 21 | “constant”: false, |
| 22 | “name”: “B”, |
| 23 | “nodeType”: “VariableDeclaration”, |
| 24 | “overrides”: null, |
| 25 | “stateVariable”: true, |
| 26 | “storageLocation”: “default”, |
| 27 | “typeDescriptions”: |
| 28 | { |
| 29 | “typeIdentifier”: “t_bool”, |
| 30 | “typeString”: “bool” |
| 31 | }, |
| 32 | “value”: null, |
| 33 | “visibility”: “internal” |
| 34 | }, |
| 35 | { |
| 36 | “constant”: false, |
| 37 | “name”: “ tokenOwner ”, |
| 38 | “nodeType”: “VariableDeclaration”, |
| 39 | “overrides”: null, |
| 40 | “stateVariable”: FALSE, |
| 41 | “storageLocation”: “default”, |
| 42 | “typeDescriptions”: |
| 43 | { |
| 44 | “typeIdentifier”: |
| 45 | “t_mapping$_t_uint256_$_t_string$_Stri |
| 46 | ng_$6_storage_$”, |
| 47 | “typeString”:“mapping(uint256=>address |
| 48 | )” |
| 49 | }, |
| 50 | { |
| 51 | “constant”: false, |
| 52 | “name”: “ ownedTokensCount ”, |
| 53 | “nodeType”: “VariableDeclaration”, |
| 54 | “overrides”: null, |
| 55 | “stateVariable”: FALSE, |
| 56 | “storageLocation”: “default”, |
| 57 | “typeDescriptions”: |
| 58 | { |
| 59 | “typeIdentifier”: |
| 60 | “t_mapping$_t_uint256_$_t_string$_Stri |
| 61 | ng_$6_storage_$”, |
| 62 | “typeString”: “mapping(uint256 |
| 63 | =>Counter)” |
| 64 | } |
| 65 | ] |

In the above-mentioned abstract syntax tree, comments are marked with // . . . . A storage position of line 11 is about a computation rule of slots. In the above-mentioned abstract syntax tree, information of objects stated in the contract in the abstract syntax tree is described below nodes of line 3, and information related to an object is placed in a node. The objects include, for example, state variables A and B, and mapping relationships “tokenOwner” and “ownedTokensCount”. For example, lines 5-19 are a Oth node about A in the abstract syntax tree, lines 20-34 are a 1^{st} node about B in the abstract syntax tree, lines 35-49 are a 2nd node about tokenOwner in the abstract syntax tree, and lines 50-64 are a 3^{rd} node about ownedTokensCount in the abstract syntax tree. Each node includes several pieces of information. On the whole, information in a node can be referred to as node information of the abstract syntax tree.

With reference to the abstract syntax tree of the contract C1, node positions of the 2 state variables A and B in the contract C1 in the abstract syntax tree are 0 and 1 respectively, and can correspond to slots at 2 positions in FIG. 6 as follows:

$$\begin{matrix}0 \times 0000 \\ 0 \times 0000\end{matrix} \begin{matrix}0000 \\ 0000\end{matrix} \begin{matrix}0000 \\ 0000\end{matrix} \begin{matrix}0000 \\ 0000\end{matrix} \begin{matrix}0000 \\ 0000\end{matrix} \begin{matrix}0000 \\ 0000\end{matrix} \begin{matrix}0000 \\ 0000\end{matrix} \begin{matrix}0000 \\ 0000\end{matrix} \begin{matrix}0000 & 0000 & 0000 & 0000 & 0000 & 0000 & 0000 & 0000 \\ 0000 & 0000 & 0000 & 0000 & 0000 & 0000 & 0000 & 0001\end{matrix}$$

The positions of the 2 slots are each 256 bits, and are 32 bytes in hexadecimal (0x). 4 consecutive hexadecimal digits in each segment separated by spaces after the 0x represent 2 bytes, so there are 16 such segments in total.

In this way, in the contract bytecodes compiled by the compiler, the 2 positions of slots can be used to replace identifiers of 2 state variables. For example, the above-mentioned 256 bits and 256 bits replace A and B respectively. In this way, when a data type is a fixed value, a storage position can be pre-allocated to each of data that are to be stored in order by fields during compilation, which is equivalent to specifying a fixed data pointer in advance.

In a process of loading and executing the contract bytecodes by the virtual machine, an operation for A is an operation for a slot position corresponding to 0x000 . . . 00 (that is, the above-mentioned slot position 0, where more 0s are replaced by ellipsis). Similarly, an operation for B is an operation for the slot position of 0x000 . . . 01.

FIG. 7 is a schematic diagram illustrating operations for slots. As shown in FIG. 7, for example, if a transaction invoking contract C1 invokes a setA ( ) function in the contract and an input parameter is a string “0001”, a virtual machine stores the slot position of a 0x000 . . . 01 as 0001 in a process of executing the transaction. Specifically, the virtual machine can push the 32-byte slot of 0x000 . . . 01 into a stack, and then push a corresponding value into the stack. In a process of interpreting execution, OPcode of an invoked function is obtained from a memory and starts to be executed. According to first-in-last-out or last-in-first-out characteristics of the stack, the value is popped up from the stack, and then the slot is popped up from the stack, such that a slot-value pair is formed. Then, a contract virtual machine executes current opcode, that is, writes the value into storage at a slot position. It can be seen that the slot is equivalent to a number, and can be used to uniquely identify state variables of the contract during contract execution. In the above-mentioned process, the stack generally uses 32 bytes as a storage unit, which is equal to a length of 1 slot. If the corresponding value may be less than, equal to or greater than 32 bytes, the value may occupy 1 unit or more units in the stack.

Further, as shown in FIG. 7, for example, if a transaction invoking contract C1 invokes a setB ( ) function in the contract and an input parameter is “36”, the virtual machine stores the slot 0x000 . . . 02 as 36 in a process of executing the transaction.

Results generated by execution of the above-mentioned two contracts can be simply expressed as follows:

$$0 \times 000 …00 : 0001 \qquad ( 1 )$$

$$0 \times 000 …01 : 36 \qquad ( 2 )$$

After the virtual machine completes execution, the virtual machine or a blockchain platform can convert slots in the 2 slot-value key-value pairs (1) and (2) into state keys. Specifically, the state key can be obtained by splicing a contract address and a slot position. For example, an address length of the contract C1 is 20 bytes, that is, 0x3321 dcaf 8911 d384 2e14 a7a4 15be 2fb1 a337 f43e. After the contract address and the slot position are spliced,

(1) the state key of the corresponding state variable A is:

$$0 \times 3321 dcaf 8911 d 3842 e 14 a 7 a 41 \; 5 be 2 fb 1 a 337 f 43 e 0000000000000000000000000000000000000000000000000000000000000000$$

(2) the state key of the corresponding state variable B is:

$$0 \times 3321 dcaf 8911 d 3842 e 14 a 7 a 415 be 2 fb 1 a 337 f 43 e 0000000000000000000000000000000000000000000000000000000000000001$$

Then, a blockchain node can store generated state key-values in an underlying database. Specifically, the blockchain node can include a tree creation module and a state database module. The tree creation module can transform the keys into the storage trie as shown in FIG. 4, and build values in the state key-values into a leaf node of the MPT. It should be noted that, as mentioned above, the state key is divided into several small segments, which are sequentially stored in tree nodes from a root to leaf nodes of the storage trie. Which segment of a state key is stored in each tree node depends on a common prefix between the state key and other state keys in the tree. From the leaf node to an internal node and then to a root node, a series of hash value changes can be caused, and the tree creation module can build kvs of the tree nodes. Further, the tree creation module transmits the changed kvs of the tree nodes to the state database module, and finally the state database module stores the kvs in a state database.

In the above-mentioned process, slots of the state variables are fixed in a compilation process, and are determined according to contract addresses and slot positions of the state variables as mentioned above. The state keys can be obtained by splicing the contract addresses and the slots. In this way, in a case of running the same contract, if the same state variables are read and written, the same slot can be used, which corresponds to a fixed state key.

It should be noted that types of the state variables A and B in the above-mentioned examples are uint256 and bool respectively, where the uint256 is 256 bits, that is, 32 bytes, and the bool type is 1 byte. The types of the state variables determine that a length of data is fixed, or data are fixed-length. In addition, types such as uint, uint8 and uint128 are also fixed-length. A certain number of arrays composed of fixed-length elements are also fixed-length. For example, uint[2] includes 2 elements, and each of the elements is of a uint type of 32 bytes, so the whole uint[2] is 64 bytes.

In addition to fixed-length data storage, variable-length data storage exists, or a data size is unpredictable. In this case, the slot position cannot be determined directly during compilation through a fixed-length method, and a different solution is used.

For example, in the contract C1, mappping (uint256=>address) tokenOwner and mappping (uint256=>Counter) ownedTokensCount are defined after the state variables A and B, that is, mapping relationships. The mapping relationships are data types having a unfixed length. With the mappping (uint256=>address) tokenOwner as an example, tokenOwner is a name of the mapping relationship.

For example, a mint function in the contract C1 is used to create a non-fungible token (NFT) resource. Its input parameter address is a recipient account address of the created NFT resource, and its input parameter token id is an identifier of the created NFT resource. Based on the above-mentioned defined mapping relationship, tokenOwner [tokenid]=to, ownedTokensCount [to] and increment ( ) are defined in the mint function. The mapping elements are state variables and can be stored in the state database. With the tokenOwner [tokenid]=to as an example, tokenid and to are two input parameters of the mint function, and the tokenid can be referred to as a key of the mapping relationship tokenOwner.

As shown in FIG. 7, when contract codes are compiled, a slot of 0x000 . . . 02 can be allocated to a name tokenOwner of the mapping relationship according to a position (a 2nd position) of a node corresponding to the tokenOwner in an abstract syntax tree. The tokenOwner is not a state variable, so no value exists in the slot. Similarly, a slot having a position value of 0x000 . . . 03 can be allocated to the mapping relationship ownedTokensCount.

When the virtual machine executes the contract C1, a slot of a mapping element corresponding to a key can be uniquely determined according to the key of a mapping relationship and a slot of a name of the mapping relationship. For example, the slot is keccak256 (key.slot), where “.” is a splicing symbol, and a slot after “.” is a position of the slot where the name of the mapping relationship is located. The number of the mapping elements in the mapping relationships is uncertain, and lengths of keys and values in the elements are uncertain. After the contract C1 is invoked several times, there may be 2 elements of the mapping relationship tokenowner, that is,

$$tokenowner [ nft 1 ] = Account 1 ;$$

$$tokenowner [ nft 2 ] = Account 2 ;$$

For a 1^{st} mapping element in the mapping relationship tokenOwner, a key is nft1, and a value is Account1. A slot position of the corresponding mapping element tokenOwner [nft 1] can be keccak256 (“nft1”0.0x000 . . . 02), and the value (for example, a data length of the value is greater than 32 bytes) can be stored in one or more consecutive slots at the beginning of the position. Similarly, for a 2nd mapping element in the mapping relationship tokenOwner, a key is nft2, and a value is Account2. A slot position of the corresponding mapping element tokenOwner [nft2] can be keccak256 (“nft2”0.0x000 . . . 02), and the value (for example, a data length of the value is greater than 32 bytes) can be stored in one or more consecutive slots at the beginning of the position.

For example, a length of a value of tokenOwner [nft1] is less than 32 bytes, and a length of a value of tokenOwner [nft2] is greater than 32 bytes and less than 64 bytes.

As shown in FIG. 7, the length of the value of the tokenOwner [nft1] is less than 32 bytes, and the value can be stored in 1 slot. A position of the slot is, for example, a value of keccak256 (“nft1”, 0x000 . . . 02), and for example:

$$0 \times 000 … 05$$

Assuming the length of the value of the tokenOwner [nft2] is greater than 32 bytes and less than 64 bytes, and the value can be stored in 2 consecutive slots. Start positions of the two slots are, for example, a value of keccak256 (“nft2”, 0x000 . . . 02). For example, positions of the two slots are as follows:

$$0 \times 000 … 07$$

$$0 \times 000 … 8.$$

Similarly, when the virtual machine executes the contract C1, a slot, that is, keccak256 (“to”0.0x000 . . . 03), of each element can be uniquely determined according to a key of a mapping element ownedTokensCount [to] and a slot of a mapping relationship ownedTokensCount. For example, as shown in FIG. 7, a slot of ownedTokensCount [Account1] can be determined as follows:

$$0 \times 5 b 4 d \qquad ed 6 c \qquad c 162 \qquad 9 f 13 \qquad 8186 \qquad f 4 b 0 \qquad 7950 \qquad 04 ad \qquad bed 7 \qquad ec 13 \qquad 374 d \qquad 15 ca \qquad 04 ec \qquad 96 f 1 \qquad 4913 \qquad 2406$$

A slot of ownedTokensCount [Account2] can be determined as follows:

$$0 \times 9019 \qquad 1 b 3 f \qquad 1 d 96 \qquad c 216 \qquad c 6 a 6 \qquad 63 \; 7 b \qquad 9 c 84 \qquad 98 bc \qquad 25 cc \qquad 907 a \qquad fe 24 \qquad 6 d 61 \qquad 1 b 3 a \qquad 8 bf 7 \qquad 27 bc \qquad 081 d$$

That is, for a contract including a mapping relationship, after a transaction invokes the contract and defines a mapping element, a slot of a mapping element can be uniquely determined according to a key of the mapping element in the transaction and a slot of the mapping relationship.

In the field of blockchain technology, in order to cope with increasing transaction volume, a solution of parallel execution of transactions is used to improve execution efficiency of the transactions. For parallel transaction execution, the plurality of transactions need to be grouped before execution of the plurality of transactions. In the related art, transactions can be grouped according to from fields and to fields of the transactions. However, when the plurality of transactions invoke the same contract, the plurality of transactions are put into a group so as to be executed in series. In actual application, the plurality of transactions may access different state variables in the contract, and cannot conflict with each other in access.

In a second related art, for a plurality of transactions invoking a contract, a pre-execution read-write set of each transaction is obtained through pre-execution of each transaction, and the plurality of transactions are grouped according to the pre-execution read-write set of each transaction. The pre-execution read-write sets of the transactions include key-value pairs of state variables accessed by the transactions in a pre-execution process. However, a solution of obtaining transaction read-write sets through pre-execution of the transactions is great in computational load and occupies more computing and storage resources.

In view of that, the embodiments of this specification provide methods for grouping transactions. For the plurality of transactions invoking the same contract, the identifiers (for example, the slot position) of the state variables that are to be accessed by each of the transactions in contract execution are determined, and the plurality of transactions are grouped according to the identifier of the state variable accessed by each of the transactions. In this way, compared with the above-mentioned second related art, the embodiments do not need to pre-execute each transaction and group each transaction based on keys of the state variables that are to be accessed by each transaction. Thus, computational load and storage resource usage of transaction grouping are reduced, granularity of transaction grouping is improved, and parallelism of transaction execution is further enhanced.

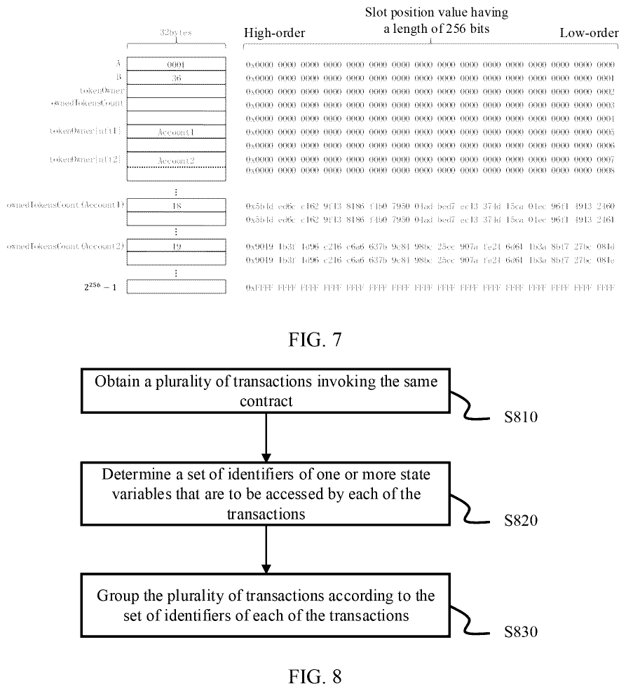

FIG. 8 is a flowchart illustrating a method for grouping transactions in a blockchain in embodiments of this specification. The method can be executed by any blockchain node in the blockchain. The method includes S810-S830 as follows.

Firstly, in S810, the blockchain node obtains a plurality of transactions invoking the same contract from transactions that are to be grouped.

Specifically, for N transactions that are to be grouped, the blockchain node can select m transactions invoking the same contract (for example, contract C1) from the N transactions according to a to field of each of the transactions.

In S820, the blockchain node determines a set of identifiers of one or more state variables that are to be accessed by each of the m transactions. A set of identifiers of a transaction includes variable identifiers of state variables that are to be accessed by the transaction during contract execution.

The variable identifier during contract execution refers to an identifier used to distinguish each of the state variables in the contract during contract execution, rather than a key, stored in a state database, of the state variable. The variable identifier is, for example, a slot of each of the state variables as mentioned above. Through the above-mentioned setting of the slots of the state variables, different slots are allocated to different state variables in a contract. When a virtual machine executes different transactions invoking the same contract, the same slot is still allocated to the same state variables in the contract. Thus, for the plurality of transactions invoking the same contract, the variable identifiers of the state variables requested to be accessed by each of the transactions during contract execution only need to be determined, such that the plurality of transactions can be correctly grouped. The plurality of transactions do not need to be grouped according to state keys of the state variables requested to be accessed by each of the transactions.

Specifically, for a fixed-length state variable in the contract accessed during transaction execution, a compiler uses a slot of the fixed-length state variable to replace an identifier of the state variable during contract code compilation. Thus, the virtual machine can directly obtain the slot of the fixed-length state variable from contract codes. In some implementations, the virtual machine can determine the slot of the fixed-length state variable accessed by the transaction from a pre-stored slot list of a fixed-length state variable read and/or written by each function in the contract.

For example, as mentioned above, in codes of the contract C1, an identifier of the above-mentioned state variable B is a slot of the state variable, that is:

$$0 \times 1.$$

The virtual machine can obtain the slot of the state variable B from the codes of the contract C1, or can determine a slot of a fixed-length state variable of the contract read and/or written by the function of the contract invoked by the transaction according to the pre-obtained slot list of fixed-length state variables of the functions of the contract.

The slot of the state variable B can be used to compute a state key of the state variable B in the state database. For example, the state key is obtained by splicing an address of the contract C1 and the slot of the state variable B as follows:

$$0 \times 3321 dcaf 8911 d 3842 e 14 a 7 a 415 be 2 fb 1 a 337 f 43 e 1.$$

It can be seen that the slot of the state variable has the much less data amount than the state key of the state variable. Storage space (for example, memory space) can be saved through grouping based on the variable identifiers of the state variables during contract execution. Moreover, a generation process of obtaining the state keys from the variable identifiers is omitted, and the number of identifier bytes of the variable identifiers is saved in a grouping process. Thus, computing resources are saved.

It can be understood that, in the embodiments of this specification, the above-mentioned variable identifiers are not limited to slots, and can be other types of identifiers, as long as the variable identifiers can uniquely identify different state variables in the contract.

When a variable-length state variable based on a mapping relationship in the contract is accessed by the transaction, the virtual machine can compute the slot of the variable-length state variable.

In some implementations, the virtual machine can obtain transaction metadata, and determine the slot of the variable-length state variable that is to be accessed by the transaction according to the transaction metadata. The transaction metadata are transaction bodies of the transactions, and include data of fields such as from fields, to fields, and data fields.

For example, transaction Tx1 is a transaction transmitted by Alice and invoking a mint function of the contract C1. For example, a transaction body of the transaction is as shown in Table 1:

TABLE 1

| | |
|---|---|
| From | Alice |
| To | Address of contract C1 |
| Data | mint( ), bob1, nft1 |
| Digital signature | |

In a Data field of the transaction Tx1, “bob1” and “nft1” are two input parameters of a mint ( ) function.

The blockchain node can pre-determine and record a slot of each fixed-length state variable defined in each contract deployed in the blockchain and a slot of a fixed-length state variable requested to be read and/or written by each function. Variable-length state variables (such as mapping elements) cannot be determined before the transactions invoke the contracts, so the state variables need to be determined for each transaction.

Specifically, assuming that the mint ( ) function invokes an ERC721 interface, the blockchain node can determine mapping relationships included in the mint ( ) function according to fixed setting of the ERC721 interface. For example, in the fixed setting of the ERC721 interface, the mint ( ) function should include tokenOwner [tokenid]=to and ownedTokensCount [to],increment ( ) so the blockchain node can directly obtain the two mapping relationships through mint ( ) function invoking of the transaction Tx1.

Then, the blockchain node can determine slots of the mapping elements read and/or written by the transaction Tx1 according to the two mapping relationships and metadata of the transaction Tx1.

Specifically, according to the two mapping relationships and the Data field of the transaction Tx1, it can be determined that the transaction Tx1 writes mapping elements tokenOwner [nft1] and ownedTokensCount [bob1]. A slot of the mapping element tokenOwner [nft1] is keccak256 (nft1.slot1). A slot of the mapping element ownedTokensCount [bob1] is keccak256 (bob1.slot2). Slotl is a slot of a mapping name tokenOwner, and slot2 is a slot of a mapping name ownedTokensCount.

Through the above-mentioned operations, a slot set of each state variable requested to be read by the transaction Tx1 and a slot set of each state variable requested to be written by the transaction Tx1 can be determined.

In some implementations, the ERC721 interface is conventional and not mandatory, so a contract developer may introduce some special logics into implementation of the interface. For example, the contract developer may modify the mint ( ) function to be as follows:

```
function mint(address to,uint256 tokenid) public {
  tokenOwner[tokenid]=to;
  ownedTokensCount[msg.sender],increment( )}
```

In this case, if the slot read and written by the transaction Tx1 is still analyzed according to the ERC721 interface, a wrong result can be obtained. Thus, codes of the mint ( ) function are read from the blockchain, and the codes of the mint ( ) function are statically analyzed, such that a mapping relationship included in the mint ( ) function can be determined. Then, according to the analyzed mapping relationship, a slot set of mapping elements read and/or written by the transaction Tx1 can be determined. Thus, a slot set (hereinafter referred to as a slot read set) of each state variable requested to be read by the transaction Tx1 and a slot set (hereinafter referred to as a slot write set) of each state variable requested to be written by the transaction Tx1 can be determined.

In S830, the blockchain node groups the plurality of transactions according to the set of identifiers of each of the transactions.

After the respective slot read sets and slot write sets of the plurality of transactions are determined as mentioned above, the plurality of transactions can be grouped based on the slot read-write sets of all the transactions according to a rule of mutual read-write exclusion and mutual write-write exclusion without mutual read-read exclusion. It can be understood that the grouping method is only one possible grouping method. In some implementations, the plurality of transactions can be grouped according to the slot accessed by each of the transactions, that is, whether the access is reading or writing is not distinguished. If two transactions access the same variable, the two transactions are mutually exclusive and need to be put into a group. If two transactions do not access the same variable, the two transactions are not mutually exclusive and can be put into different groups, that is, the two transactions can be executed in parallel.

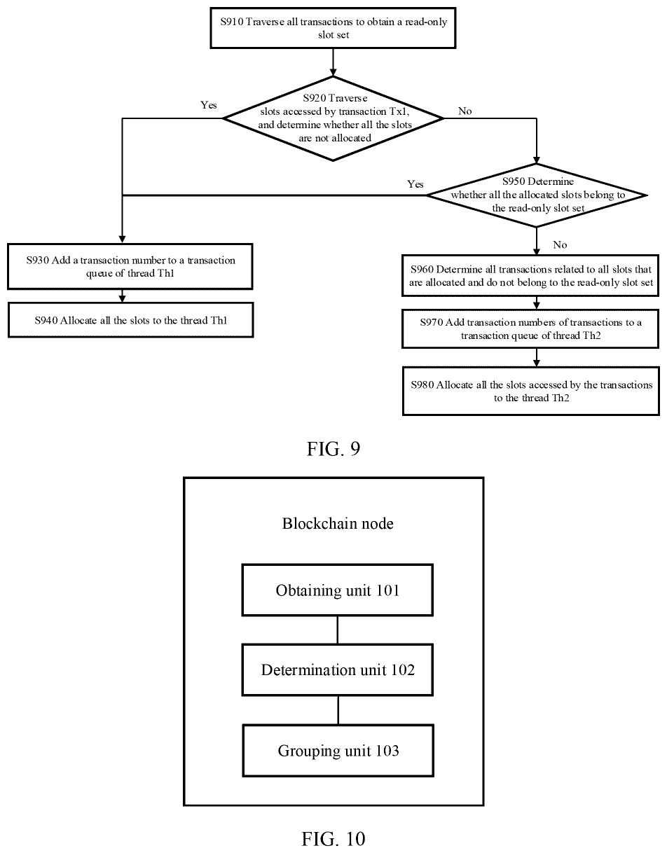

FIG. 9 is a flowchart illustrating a method for grouping transactions according to a slot read set and a slot write set of each transaction in embodiments of this specification.

As shown in FIG. 9, in S910, a blockchain node traverses slot read sets and slot write sets of the above-mentioned m transactions so as to obtain a read-only slot set.

Specifically, the blockchain node puts slots included in any one of the slot read sets and not included in all the slot write sets into the read-only slot set by traversing the slot read sets and the slot write sets of the above-mentioned m transactions. That is, slots in the read-only slot set belong to a slot read set and do not belong to any one of the slot write sets.

In S920, for transaction Tx1 of the m transactions, the blockchain node traverses slots accessed by the transaction Tx1, and determines whether all the slots accessed by the transaction Tx1 are not allocated to threads for parallel execution.

Specifically, in the embodiments of this specification, a transaction queue can be set corresponding to each execution thread used to execute the transactions. For example, when a transaction is allocated to thread Th1, a number of the transaction is added to the transaction queue. Meanwhile, whether to record the slots is determined in a slot list. If a slot is not recorded, the slot is added to the slot list, each slot in all the slots accessed by the transaction Tx1 is recorded as allocated to the thread Th1 in the slot list, and each slot in all the slots is recorded as associated with the transaction Tx1.

For each slot accessed by the transaction Tx1, the blockchain node can identify the slot in the slot list. If the slot is not recorded in the slot list, it can be determined that the slot is not allocated to a thread. If the slot is recorded in the slot list, it can be determined that the slot is allocated to a thread.

When all the slots accessed by the transaction Tx1 are traversed and all the slots are not determined to be allocated, S930 can be executed. The blockchain node adds the transaction number of the transaction Tx1 to the transaction queue of the thread Th1. The thread Th1 is, for example, a most idle thread of the plurality of threads for parallel transaction execution. Specifically, the blockchain node can traverse the transaction queue of each thread and determine a thread having a least number of transactions in the transaction queue as the most idle thread.

In S940, the blockchain node allocates all the slots accessed by the transaction Tx1 to the thread Th1.

Specifically, the blockchain node can add all the slots to the slot list and record that each slot in all the slots is allocated to the thread Th1 and associated with the transaction Tx1.

When S920 determines that all the slots accessed by the transaction Tx1 include some allocated slots, that is, when not all slots are allocated, the blockchain node executes S950 to determine whether all allocated slots belong to the read-only slot set.

If all the allocated slots belong to the read-only slot set, the blockchain node can execute S930.

If at least part of all the allocated slots do not belong to the read-only slot set, S960 is executed.

In S960, all transactions related to all slots that are allocated and do not belong to the read-only slot set are determined.

In S970, transaction numbers of the transactions are added to the transaction queue of thread Th2. The thread Th2 is, for example, a most idle thread of the plurality of threads for parallel transaction execution. The thread Th2 can be the same as the above-mentioned thread Th 1.

In S980, all the slots accessed by the transactions are allocated to the thread Th2.

Specifically, the blockchain node can add all the slots to the slot list and record that each slot in all the slots is allocated to the thread Th2 and associated with the transaction Tx1.

S920-S980 in FIG. 9 are executed for each of the m transactions, and the m transactions can be allocated to the transaction queue of each of the threads according to a rule of mutual read-write exclusion and mutual write-write exclusion without mutual read-read exclusion, such that grouping of the m transactions is completed.

FIG. 10 is a structural diagram illustrating a blockchain node in embodiments of this specification. The blockchain node is configured to execute the method shown in FIG. 8 or FIG. 9. The blockchain node includes: an obtaining unit 101 configured to obtain a plurality of first transactions from a plurality of transactions that are to be grouped, where the plurality of first transactions invoke the same contract; a determination unit 102 configured to determine a set of identifiers corresponding to one or more state variables of the contract that is to be accessed by each of the first transactions, where the set of identifiers includes variable identifiers of the state variables during contract execution, and the variable identifiers are used to determine keys of the state variables in a state database; and a grouping unit 103 configured to group the plurality of first transactions according to the set of identifiers of each of the first transactions.

The embodiments of this specification further provide computer-readable storage media. The computer-readable storage medium stores a computer program. When the computer program is executed in a computer, the computer is caused to execute the method shown in FIG. 8 or FIG. 9.

The embodiments of this specification further provide blockchain nodes. The blockchain node includes a memory and a processor. The memory stores executable code. When the processor executes the executable codes, the method shown in FIG. 8 or FIG. 9 is implemented.

In the 1990s, whether a technical improvement is a hardware improvement (for example, an improvement to a circuit structure such as a diode, a transistor, or a switch) or a software improvement (an improvement to a method flow) can be clearly distinguished. However, with the development of technology, improvements to many method flows can be regarded as direct improvements to hardware circuit structures. Almost all designers obtain corresponding hardware circuit structures by programming improved method flows into hardware circuits. Thus, improvements to a method flow can be implemented through hardware entity modules. For example, a programmable logic device (PLD), such as a field programmable gate array (FPGA), is such an integrated circuit whose logic functions are determined through device programming by users. The designers perform programming to “integrate” a digital system to a PLD without requesting a chip manufacturer to design and produce an application-specific integrated circuit chip. Moreover, now, instead of manually making an integrated circuit chip, this programming is mostly executed with “logic compiler” software, which is similar to a software compiler used when the program is developed, and the original code before it is compiled also has to be written in a specific programming language, which is referred to as Hardware Description Language (HDL), and there is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. It should be clear to a person skilled in the art that a hardware circuit that implements a logical method flow can be readily obtained once the method flow is logically programmed through the above-mentioned several hardware description languages and is programmed into an integrated circuit.

Controllers can be implemented through any appropriate method. For example, the controllers can be microprocessors or processors, or computer-readable media that store computer readable program codes (such as software or firmware) that can be executed by the microprocessors or the processors, logic gates, switches, application specific integrated circuits (ASICs), programmable logic controllers, or embedded microprocessors. Examples of the controllers include, but are not limited to, the following microprocessors: ARC 625D, Atmel AT91SAM, Microchip PIC18F26K20, and Silicon Labs C8051F320. The memory controllers can also be implemented as part of control logics of memories. A person skilled in the art also knows that in addition to implementing the controllers through only the computer-readable program codes, logic programming can be performed on method steps to enable the controllers to implement the same function in a form of logic gates, switches, application specific integrated circuits, programmable logic controllers, embedded microcontrollers, etc. Thus, the controller can be considered to be a hardware component, while an apparatus included in the controller and used to implement various functions can also be considered as a structure in the hardware component. Or, the apparatus for implementing various functions can even be considered as both a software module for implementing a method and the structure in the hardware component.

The system, apparatus, module, or unit stated in the above-mentioned embodiments can specifically be implemented by a computer chip or entity, or can be implemented by a product having a certain function. A typical implementing device is a server system. Clearly, this application does not exclude that with development of future computer technologies, computers that implement functions of the above-mentioned embodiments can be, for example, personal computers, laptop computers, vehicular man-machine interaction devices, cellular phones, camera phones, smart phones, personal digital assistants, media players, navigation devices, e-mail devices, game consoles, tablet computers, wearable devices, or any their combinations.

Although one or more embodiments of this specification provide method operating steps as described in the embodiments or flowcharts, more or fewer operating steps can be included on the basis of conventional or noncreative means. The order of steps enumerated in the embodiments is only one of many step execution orders and does not represent a unique order of execution. During execution in actual apparatuses or end products, execution can be performed sequentially or in parallel in the method order shown in the embodiments or the accompanying drawings (for example, through parallel processors or multithreaded processing environments, or even distributed data processing environments). The terms such as “include”, “comprise” or any other their variations are intended to cover non-exclusive inclusion, such that processes, methods, products, or devices including a series of elements include not only the elements but also other elements not explicitly listed, or elements inherent to such processes, methods, products, or devices. Without further limitations, existence of additional same or equivalent elements in the processes, methods, products or devices including the elements is not excluded. For example, if the words such as first and second are used for indicating names, the words do not indicate any particular order.

For convenience of description, the above-mentioned apparatuses are divided into various modules according to functions for respective descriptions. Clearly, during implementation of one or more embodiments of this specification, the functions of the modules can be implemented in the same one or more pieces of software and/or hardware, or modules implementing the same function can be implemented through a combination of a plurality of sub-modules or sub-units, etc. The above-mentioned apparatus embodiments are merely schematic, for example, division of units is merely logical function division. In actual implementation, there are other modes of division. For example, a plurality of units or components can be combined or can be integrated into another system, or some features can be omitted, or not executed. In addition, the displayed or discussed mutual couplings or direct couplings or communication connections can be implemented through some interfaces. Indirect couplings or communication connections between apparatuses or units can be implemented in electronic, mechanical, or other forms.

This application is described with reference to the flowchart and/or block charts of methods, apparatuses (systems), and computer program products according to the embodiments of this application. It should be understood that each flow and/or block in flowcharts and/or block charts, and combinations of flows and/or blocks in the flowcharts and/or the block charts, can be implemented by computer program instructions. The computer program instructions can be provided for a general-purpose computer, a special-purpose computer, an embedded processor, or a processor of another programmable data processing device to generate a machine, such that instructions executed by the computer or the processor of the another programmable data processing device generate an apparatus for implementing a specific function in one or more flows in the flowcharts and/or in one or more blocks in the block charts.

Alternatively, the computer program instructions can be stored in a computer-readable memory that can instruct a computer or another programmable data processing device to work in a specific way, such that the instructions stored in the computer-readable memory generate an artifact that includes an instruction apparatus. The instruction apparatus implements a specific function in one or more flows in the flowcharts and/or in one or more blocks in the block charts.

Alternatively, the computer program instructions can be loaded onto a computer or another programmable data processing device, such that a series of operating steps are performed on the computer or another programmable device, to generate computer-implemented processing. Thus, the instructions executed on the computer or another programmable device provide steps for implementing a specific function in one or more flows in the flowcharts and/or in one or more blocks in the block charts.

In a typical configuration, a computing device includes one or more central processing units (CPUs), input/output interfaces, network interfaces, and memories.

The memories can include a volatile memory, a random access memory (RAM), or a nonvolatile memory in computer-readable media, and for example, a read-only memory (ROM) or a flash RAM. A memory is an example of the computer-readable medium.

The computer-readable media are nonvolatile, volatile, removable and non-removable media that can store information through any method or technology. The information can be computer-readable instructions, data structures, program modules, or other data. Examples of the computer storage media include, but are not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a read-only optical disc read-only memory (CD-ROM), a digital versatile disc (DVD) or other optical memories, a magnetic cassette, a magnetic tape or disk memory, a graphene memory or other magnetic storage devices, or any other non-transmission media that can be used to store information that can be accessed by computing devices. Based on the definition herein, the computer-readable media do not include transitory media such as modulated data signals and carriers.

A person skilled in the art should understand that one or more embodiments of this specification can be provided as methods, systems, or computer program products. Thus, one or more embodiments of this specification can use forms of fully hardware embodiments, fully software embodiments, or embodiments combining software and hardware aspects. Moreover, one or more embodiments of this specification can use a form of computer program products implemented on one or more computer available storage media (including, but not limited to, disk memories, CD-ROMs, optical memories, etc.) including computer available program codes.

One or more embodiments of this specification can be described in the general context, such as program modules, of computer-executable instructions executed by computers. Generally, the program modules include routines, programs, objects, components, data structures, etc. for executing specific tasks or implementing specific abstract data types. One or more embodiments of this specification can be practiced in distributed computing environments. In the distributed computing environments, tasks are executed by remote processing devices that are connected through communication networks. In the distributed computing environments, the program modules can be located in both local and remote computer storage media including storage devices.

All the embodiments of this specification are described in a progressive way. Reference can be made mutually for the same or similar parts of the embodiments. All the embodiments focus on differences from other embodiments. Particularly, system embodiments are basically similar to method embodiments, and are described briefly. Reference can be made to some description in the method embodiments for related parts. In the description of this specification, reference to terms such as “embodiments”, “some embodiments”, “examples”, “specific examples”, or “some examples” means that specific features, structures, materials, or characteristics described in conjunction with the embodiments or examples are included in at least one of the embodiments or examples of this specification. In this specification, illustrative expressions of the above-mentioned terms do not necessarily refer to the same embodiments or examples. Moreover, the described specific features, structures, materials, or characteristics can be combined in any suitable manner in any one or more embodiments or examples. In addition, a person skilled in the art can combine and associate different embodiments or examples and features of different embodiments or examples described in this specification without any conflicts between the embodiments or examples and the features of the embodiments or examples.

What are described above are merely embodiments of one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification should fall within the scope of the claims.

What is claimed is:

1. A computer-implemented method for grouping transactions in a blockchain, executed by a blockchain node, comprising:
obtaining a plurality of first transactions from a plurality of transactions that are to be grouped, wherein the plurality of first transactions invoke the same contract;
determining a set of identifiers corresponding to one or more state variables of the contract that is to be accessed by each of the first transactions, wherein the set of identifiers comprise variable identifiers of the state variables during contract execution, and the variable identifiers are used to determine keys of the state variables in a state database; and
grouping the plurality of first transactions according to the set of identifiers of each of the first transactions.

2. The computer-implemented method according to claim 1, wherein the contract corresponds to a plurality of numbers arranged in order by value, the variable identifiers comprise one of the plurality of numbers, and the keys of the state variables are generated based on a contract address of the contract and the variable identifiers of the state variables.

3. The computer-implemented method according to claim 1, wherein the set of identifiers comprises a first set and a second set, the first set comprises variable identifiers of state variables of the contract requested to be read by the first transactions, and the second set comprises variable identifiers of state variables of the contract requested to be written by the first transactions, and
the grouping the plurality of first transactions according to the set of identifiers of each of the first transactions comprises: putting two first transactions into the same transaction group according to the first set and the second set of each of the first transactions when an access conflict occurs between the two first transactions.

4. The computer-implemented method according to claim 1, wherein the state variables comprise a first state variable, the first state variable is a fixed-length variable, and a first variable identifier of the first state variable is determined based on a stated position of the first state variable in the contract.

5. The computer-implemented method according to claim 4, wherein the first variable identifier of the first state variable is determined by operations comprising:
generating an abstract syntax tree of the contract, wherein the abstract syntax tree comprises a plurality of nodes arranged sequentially, the plurality of nodes correspond to a plurality of objects stated in the contract, an arrangement order of the plurality of nodes corresponds to stated positions of the plurality of objects in the contract, and the plurality of objects comprise the first state variable; and
determining the first variable identifier according to an arrangement position of a first node corresponding to the first state variable in the abstract syntax tree.

6. The computer-implemented method according to claim 2, wherein the state variables comprise a second state variable, the second state variable and a target parameter satisfy a first mapping relationship, the first mapping relationship corresponds to a first number of the plurality of numbers, the first number is determined based on a stated position of the first mapping relationship in the contract, and the determining a set of identifiers corresponding to one or more state variables of the contract that is to be accessed by each of the first transactions comprises:
determining a second variable identifier of the second state variable based on the target parameter and the first number.

7. The computer-implemented method according to claim 6, wherein the first number is determined by operations comprising:
generating an abstract syntax tree of the contract, wherein the abstract syntax tree comprises a plurality of nodes arranged sequentially, the plurality of nodes correspond to a plurality of objects stated in the contract, an arrangement order of the plurality of nodes corresponds to stated positions of the plurality of objects in the contract, and the plurality of objects comprise the first mapping relationship; and
determining the first number according to an arrangement position of a second node corresponding to the first mapping relationship in the abstract syntax tree.

8. The computer-implemented method according to claim 6, wherein the plurality of first transactions comprise a second transaction, the second transaction comprises access to the second state variable, and the target parameter comprises one or more of: data in transaction metadata of the second transaction, or a value of a third state variable of the contract.

9. The computer-implemented method according to claim 8, wherein the second transaction invokes a first function of the contract, and the determining a set of identifiers corresponding to one or more state variables of the contract that is to be accessed by each of the first transactions further comprises:
determining the first mapping relationship according to the first function; and
obtaining the first number corresponding to the first mapping relationship.

10. The computer-implemented method according to claim 9, wherein the determining the first mapping relationship according to the first function comprises:
determining the first mapping relationship according to a pre-obtained correspondence between the first function and the first mapping relationship.

11. The computer-implemented method according to claim 9, wherein the determining the first mapping relationship according to the first function comprises:
reading a code of the first function from the blockchain; and
determining the first mapping relationship according to the code of the first function.

12. The computer-implemented method according to claim 3, wherein the grouping the plurality of first transactions according to the set of identifiers of each of the first transactions comprises:
traversing the first set and the second set of each of the first transactions;
obtaining a set of read-only identifiers, wherein the variable identifiers comprised in the set of read-only identifiers belong to one of the first set and do not belong to any one of the second set;
in response to determining that one or more fourth variable identifiers of one or more fourth state variables requested to be accessed by a third transaction of the plurality of first transactions are allocated to one of a plurality of threads, determining one or more fifth variable identifiers that do not belong to the set of read-only identifiers in the one or more fourth variable identifiers, wherein the plurality of threads are used to execute the plurality of first transactions in parallel;
determining all fourth transactions associated with all the one or more fifth variable identifiers, wherein all the fourth transactions comprise the third transaction;
adding transaction numbers of all the fourth transactions to a transaction queue of a first thread in the plurality of threads; and
allocating all state variables accessed by all the fourth transactions to the first thread.

13. A blockchain node, comprising:
one or more processors; and
one or more tangible, non-transitory, machine-readable media storing one or more instructions that, when executed by the one or more processors, perform one or more operations comprising:
obtaining a plurality of first transactions from a plurality of transactions that are to be grouped, wherein the plurality of first transactions invoke the same contract;
determining a set of identifiers corresponding to one or more state variables of the contract that is to be accessed by each of the first transactions, wherein the set of identifiers comprise variable identifiers of the state variables during contract execution, and the variable identifiers are used to determine keys of the state variables in a state database; and
grouping the plurality of first transactions according to the set of identifiers of each of the first transactions.

14. The blockchain node according to claim 13, wherein the contract corresponds to a plurality of numbers arranged in order by value, the variable identifiers comprise one of the plurality of numbers, and the keys of the state variables are generated based on a contract address of the contract and the variable identifiers of the state variables.

15. The blockchain node according to claim 13, wherein the set of identifiers comprises a first set and a second set, the first set comprises variable identifiers of state variables of the contract requested to be read by the first transactions, and the second set comprises variable identifiers of state variables of the contract requested to be written by the first transactions, and
the grouping the plurality of first transactions according to the set of identifiers of each of the first transactions comprises: putting two first transactions into the same transaction group according to the first set and the second set of each of the first transactions when an access conflict occurs between the two first transactions.

16. The blockchain node according to claim 13, wherein the state variables comprise a first state variable, the first state variable is a fixed-length variable, and a first variable identifier of the first state variable is determined based on a stated position of the first state variable in the contract.

17. The blockchain node according to claim 16, wherein the first variable identifier of the first state variable is determined by operations comprising:
generating an abstract syntax tree of the contract, wherein the abstract syntax tree comprises a plurality of nodes arranged sequentially, the plurality of nodes correspond to a plurality of objects stated in the contract, an arrangement order of the plurality of nodes corresponds to stated positions of the plurality of objects in the contract, and the plurality of objects comprise the first state variable; and
determining the first variable identifier according to an arrangement position of a first node corresponding to the first state variable in the abstract syntax tree.

18. The blockchain node according to claim 14, wherein the state variables comprise a second state variable, the second state variable and a target parameter satisfy a first mapping relationship, the first mapping relationship corresponds to a first number of the plurality of numbers, the first number is determined based on a stated position of the first mapping relationship in the contract, and the determining a set of identifiers corresponding to one or more state variables of the contract that is to be accessed by each of the first transactions comprises:
determining a second variable identifier of the second state variable based on the target parameter and the first number.

19. The blockchain node according to claim 18, wherein the first number is determined by operations comprising:
generating an abstract syntax tree of the contract, wherein the abstract syntax tree comprises a plurality of nodes arranged sequentially, the plurality of nodes correspond to a plurality of objects stated in the contract, an arrangement order of the plurality of nodes corresponds to stated positions of the plurality of objects in the contract, and the plurality of objects comprise the first mapping relationship; and
determining the first number according to an arrangement position of a second node corresponding to the first mapping relationship in the abstract syntax tree.

20. A non-transitory, computer-readable medium storing one or more instructions executable by a computer system to perform operations comprising:
obtaining a plurality of first transactions from a plurality of transactions that are to be grouped, wherein the plurality of first transactions invoke the same contract;
determining a set of identifiers corresponding to one or more state variables of the contract that is to be accessed by each of the first transactions, wherein the set of identifiers comprise variable identifiers of the state variables during contract execution, and the variable identifiers are used to determine keys of the state variables in a state database; and
grouping the plurality of first transactions according to the set of identifiers of each of the first transactions.
